(19) United States
(12) Patent Application Publication
(10) Pub. No.: US 2025/0174713 A1
(43) Pub. Date: May 29, 2025

(54) BIPOLAR SECONDARY BATTERY

(71) Applicant: TOYOTA JIDOSHA KABUSHIKI KAISHA, Toyota-shi (JP)

(72) Inventor: Shingo KOMURA, Nagakute-shi (JP)

(73) Assignee: TOYOTA JIDOSHA KABUSHIKI KAISHA, Toyota-shi (JP)

(21) Appl. No.: 18/797,845

(22) Filed: Aug. 8, 2024

(30) Foreign Application Priority Data
Nov. 24, 2023 (JP) 2023-199460

(51) Int. Cl. H01M 10/0562; H01M 4/02; H01M 4/36; H01M 50/143; H01M 50/242; H01M 50/249

(52) U.S. Cl. CPC H01M 10/0562; H01M 4/366; H01M 50/143; H01M 50/242; H01M 50/249; H01M 2004/029; H01M 2220/20

(57) ABSTRACT

A bipolar secondary battery includes: a stack of energy storage modules, each of the energy storage modules being composed of a stack of a bipolar electrode and a separator, the bipolar electrode including a cathode active material layer on one surface of a current collector and an anode active material layer on another surface of the current collector, and the energy storage modules being stacked in a vehicle up-down direction in such an attitude that wide surfaces of the energy storage modules face in the vehicle up-down direction; and a cushioning material having a dilatancy property and disposed so as to cover a side peripheral surface of the stack of the energy storage modules.

### CROSS-REFERENCE TO RELATED APPLICATION

This application claims priority to Japanese Patent Application No. 2023-199460 filed on Nov. 24, 2023, incorporated herein by reference in its entirety.

### BACKGROUND

### 1. Technical Field

The present disclosure relates to bipolar secondary batteries.

### 2. Description of Related Art

WO 2012/081173 discloses a technique related to a battery pack in which a module composed of a plurality of cells connected together is housed in an exterior casing. In this battery pack, at least part of the cells is covered by a cushioning material having a dilatancy property.

### SUMMARY

In bipolar secondary batteries, it is preferable to reduce short-circuiting between electrodes and improve volume efficiency.

An object of the present disclosure is to provide a bipolar secondary battery in which short-circuiting between electrodes is reduced and volume efficiency is improved.

A bipolar secondary battery according to claim 1 includes:
a stack of energy storage modules, each of the energy storage modules being composed of a stack of a bipolar electrode and a separator, the bipolar electrode including a cathode active material layer on one surface of a current collector and an anode active material layer on another surface of the current collector, and the energy storage modules being stacked in a vehicle up-down direction in such an attitude that wide surfaces of the energy storage modules face in the vehicle up-down direction; and
a cushioning material having a dilatancy property and disposed so as to cover a side peripheral surface of the stack of the energy storage modules.

The bipolar secondary battery according to claim 1 includes the cushioning material having the dilatancy property and disposed so as to cover the side peripheral surface of the stack of the energy storage modules. Therefore, the bipolar electrode is surrounded by the cushioning material having the dilatancy property. Accordingly, when a strong external force is applied from the side of the bipolar secondary battery in a short time in case of a collision, the cushioning material having the dilatancy property becomes solid and hard. This reduces deformation of the bipolar secondary battery and cracking of the separator. As a result, short-circuiting between electrodes can be reduced.

Moreover, since the cushioning material is disposed so as to cover the side peripheral surface of the stack, the volume efficiency can be improved compared to the case where the cushioning material is provided outside or inside a housing that houses the stack. It is therefore possible to provide a bipolar secondary battery in which short-circuiting between electrodes is reduced and the volume efficiency is improved.

According to the bipolar secondary battery according to claim 2, the bipolar secondary battery according to claim 1 may further include a frame-shaped member that holds a peripheral edge of the bipolar electrode.

The cushioning material may be disposed so as to cover a side peripheral surface of the frame-shaped member.

In the bipolar secondary battery according to claim 2, the cushioning material is disposed so as to cover the side peripheral surface of the frame-shaped member that holds the peripheral edge of the bipolar electrode. Therefore, the bipolar electrode is surrounded by the cushioning material having the dilatancy property with the frame-shaped member interposed therebetween. Accordingly, the external force applied from the side of the bipolar secondary battery is dispersed by the frame-shaped member. This reduces cracking of the separator, so that short-circuiting between the electrodes can further be reduced.

According to the bipolar secondary battery according to claim 3, in the bipolar secondary battery according to claim 1 or 2, the cushioning material may be a bag-shaped container enclosing a non-flammable liquid or a flame retardant liquid.

In the bipolar secondary battery according to claim 3, the cushioning material is a bag-shaped container enclosing a non-flammable liquid or a flame retardant liquid. The cushioning material is thus formed with a simple configuration. Moreover, since the cushioning material is made non-flammable or flame retardant, smoking and ignition can be reduced.

According to the bipolar secondary battery according to claim 4, in the bipolar secondary battery according to any one of claims 1 to 3, the cushioning material may support the energy storage modules.

In the bipolar secondary battery according to claim 4, the cushioning material supports the energy storage module. Therefore, the cushioning material functions as a spacer that maintains the spacing between the energy storage modules. Accordingly, deformation like denting of the bipolar secondary battery due to, for example, a negative pressure is reduced without the need to newly install a spacer. As a result, deformation of the bipolar secondary battery can be reduced while improving the volume efficiency.

According to the bipolar secondary battery according to claim 5, in the bipolar secondary battery according to any one of claims 1 to 4, the bipolar secondary battery may be an all-solid-state battery.

In the bipolar secondary battery according to claim 5, the bipolar secondary battery is an all-solid-state battery in which short-circuiting between electrodes is reduced and the volume efficiency is improved.

As described above, according to the bipolar secondary battery of the present disclosure, it is possible to reduce short-circuiting between the electrodes and improve the volume efficiency.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically showing a bipolar secondary battery according to an embodiment;

FIG. 2 is a cross-sectional view showing a bipolar secondary battery according to the embodiment, and shows an II-II cross-section of FIG. 1;

FIG. 3 is a cross-sectional view illustrating an energy storage module according to the embodiment; and

FIG. 4 is a graph showing the results of an effect confirmation test of a bipolar secondary battery.

### DETAILED DESCRIPTION OF EMBODIMENTS

Hereinafter, a bipolar secondary battery according to an embodiment will be described with reference to the drawings. The bipolar secondary battery according to the embodiment is mounted on a vehicle such as a battery electric vehicle or a hybrid electric vehicle, and is used as an in-vehicle power supply of the vehicle. In the drawings, an arrow UP indicates an upper side in the up-down direction of the bipolar secondary battery, an arrow FR indicates a front side in the front-rear direction of the bipolar secondary battery, and an arrow LH indicates a left side in the left-right direction of the bipolar secondary battery. Further, the upper part of the bipolar secondary battery coincides with the upper part of the vehicle on which the bipolar secondary battery is mounted.

### Configuration of the Bipolar Secondary Battery 10

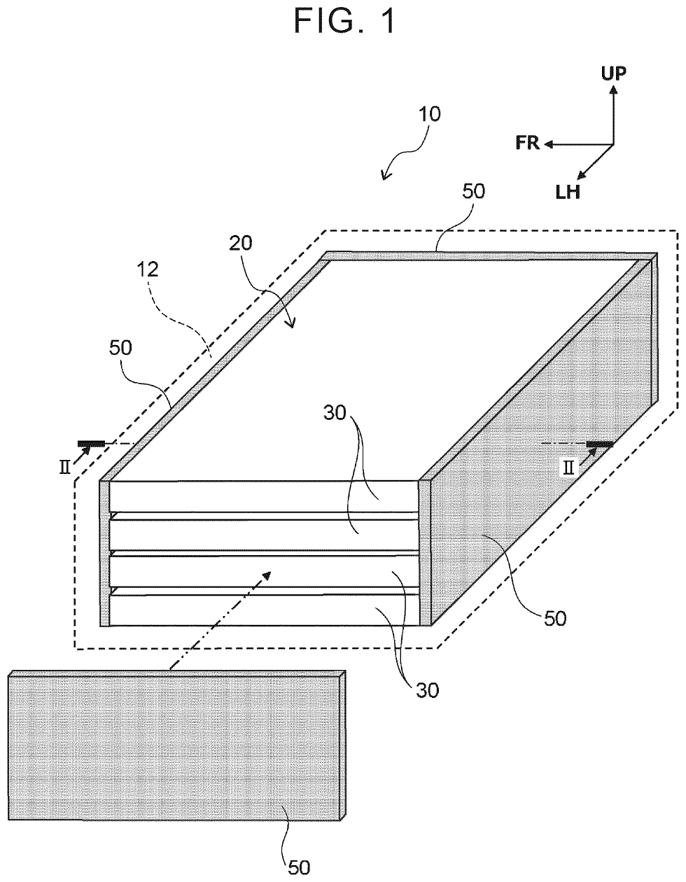

As illustrated in FIG. 1, the bipolar secondary battery 10 includes a case 12, a stack 20 accommodated in the case 12, and a cushioning material 50 disposed between the stack 20 and the case 12.

### Stack 20

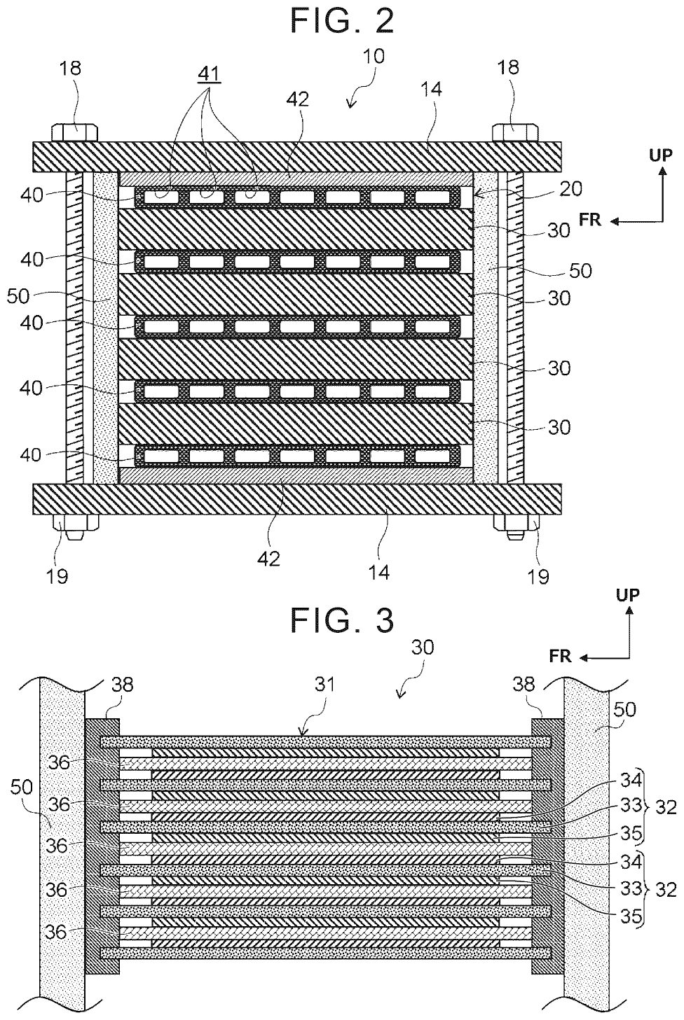

As illustrated in FIG. 2, the stack 20 includes a plurality of (in the present embodiment, four) energy storage modules 30 and a plurality of (in the present embodiment, five) conductive plates 40. The stack 20 is formed by alternately stacking the energy storage module 30 and the conductive plate 40 in the vehicle up-down direction in a posture in which the wide surface of the energy storage module 30 faces the vehicle up-down direction. That is, in the stack 20, the stacking direction is the vehicle up-down direction in a state in which the bipolar secondary battery 10 is mounted on the vehicle. The bipolar secondary battery 10 may include at least one energy storage module 30 and at least one conductive plate 40.

### Energy Storage Module 30

The energy storage module 30 is formed in a rectangular plate shape in which the vehicle up-down direction is a plate thickness direction. The energy storage module 30 is, for example, a secondary battery such as a nickel-hydrogen secondary battery or a lithium-ion secondary battery.

As illustrated in FIG. 3, the energy storage module 30 includes an electrode stack portion 31 and a frame-shaped member 38 that surrounds the side peripheral surface of the electrode stack portion 31.

### Electrode Stack Portion 31

In the electrode stack portion 31, a plurality of bipolar electrodes 32 are stacked in the vehicle up-down direction via a separator 36. The electrode stack portion 31 is formed by stacking the bipolar electrodes 32 in the vehicle up-down direction in a posture in which the wide surface of the bipolar electrodes 32 faces the vehicle up-down direction. The bipolar electrode 32 is formed in a rectangular plate shape in which the vehicle up-down direction is a plate thickness direction.

The bipolar electrode 32 includes a current collector 33, a cathode active material layer 34 formed on the upper surface (one surface) of the current collector 33, and an anode active material layer 35 formed on the lower surface (the other surface) of the current collector 33.

The separator 36 is formed in a rectangular plate shape in which the vehicle up-down direction is a plate thickness direction. The separator 36 is disposed between the bipolar electrodes 32 adjacent to each other in the stacking direction. The separator 36 separates the cathode active material layer 34 and the anode active material layer 35 adjacent to each other in the electrode stack portion 31, thereby reducing electrical short-circuiting between the electrodes. The bipolar electrode 32 and the separator 36 are impregnated with an electrolytic solution.

### Frame-Shaped Member 38

The frame-shaped member 38 is formed in a frame shape so as to surround the side periphery of the electrode stack portion 31. The frame-shaped member 38 can be formed into a frame shape by, for example, disposing the melted thermoplastic resin on the peripheral surface of the electrode stack portion 31 and cooling it. The frame-shaped member 38 holds the peripheral edges of the plurality of bipolar electrodes 32 and seals the space so that a space is formed between the bipolar electrodes 32 adjacent to each other in the vehicle up-down direction.

### Conductive Plate 40

The conductive plate 40 is made of, for example, a conductive material such as metal, and has conductivity. The conductive plate 40 is electrically connected to the energy storage modules 30 adjacent to each other in the vehicle up-down direction, and a plurality of energy storage modules 30 are connected in series via the conductive plate 40. Charging and discharging of the plurality of energy storage modules 30 are performed via external terminals (not shown).

The conductive plate 40 also functions as a heat dissipation plate for dissipating heat generated in the energy storage module 30. The conductive plate 40 is provided with a plurality of gaps 41 extending in the left-right direction. As the cooling air passes through the gap 41, the heat generated in the energy storage module 30 can be efficiently discharged to the outside.

### Case 12

As shown in FIG. 2, the case 12 includes a pair of upper and lower end plates 14. The pair of upper and lower end plates 14 are arranged so as to sandwich the stack 20. A bolt 18 and a nut 19 as a restraining member are attached to the pair of upper and lower end plates 14, so that the stack 20 is compressed in the vehicle up-down direction (stacking direction). In other words, the stack 20 is accommodated in the case 12 in a state of being compressed in the vehicle up-down direction.

An electrically insulating film 42 is disposed on an inner surface of the pair of end plates 14 in the vehicle up-down direction, and the case 12 and the energy storage module 30 are insulated from each other.

### Cushioning Material 50

As shown in FIG. 1, the cushioning material 50 is formed of a material having a dilatancy property, and has a configuration in which an increase rate of the shear stress (flow resistance) increases as the shear (flow) speed increases. That is, the cushioning material 50 has a speed dependency depending on its ease of deformation, and is easily deformed for input at a low speed, and is hardly deformed for input at a high speed.

The cushioning material 50 has a dilatancy property such as, for example, a suspension in which fine powder such as potato starch or corn starch is suspended, or a suspension in which ceramic particles are impregnated into Kevlar (registered trademark) material.

In the cushioning material 50, the ratio of the viscosity γ (γ=100) at the shear rate of 100 [S⁻¹] to the viscosity y (Y=0.01) at the shear rate of 0.01 [S⁻¹] at 25° C. is preferably greater than 1000. That is, it is preferable to satisfy the following relational expression (1) at 25° C.

γ(γ=100)/γ(γ=0.01)>1000 (1)

From the viewpoint of flame retardancy, the cushioning material 50 is preferably non-flammable or flame retardant. The cushioning material 50 preferably has an insulating property from the viewpoint of reducing electric leakage.

It is preferable that the cushioning material 50 has a specific heat of 1.4 [J/(g·K)] or higher from the viewpoint of lowering the temperature of the flue gas.

The thickness of the cushioning material 50 is preferably 60 [mm] or less from the viewpoint of not deteriorating the volume-efficiency. From the viewpoint of achieving both volumetric efficiency and impact resistance, the cushioning material 50 is preferably 10 [mm] or more, and more preferably 20 [mm] or more.

As shown in FIGS. 1 and 2, the cushioning material 50 is disposed so as to cover the side peripheral surface of the stack 20. The cushioning material 50 is attached to the frame-shaped member 38 by, for example, welding, and is disposed so as to cover the side peripheral surface of the frame-shaped member 38. Accordingly, the cushioning material 50 is configured to support the energy storage module 30. The cushioning material 50 has a height extending from the lower surface to the upper surface of the stack 20.

The cushioning material 50 may be covered in a bag-shaped container such as a film that can be easily deformed. Four bag-shaped containers may be provided corresponding to each side surface of the stack 20, or may be formed in a frame shape surrounding the side surface of the stack 20, or may be divided into a plurality of portions.

### Effect Identification Test

A test was conducted to confirm the impact resistance effect of the bipolar secondary battery 10 according to the embodiment.

In the test, Examples 1 to 5 and Comparative Examples 1 to 3 were prepared. The bipolar secondary batteries 10 of Examples 1 to 5 were formed by stacking four energy storage modules 30 in which 30 bipolar electrodes 32 were stacked. In the bipolar secondary batteries 10 of Examples 1 to 5, the constrained form A was set so that the constrained weight of the energy storage module 30 was set to about 40 [kN]. The bipolar secondary battery 10 of Example 1 includes a cushioning material 50 having a 10 [mm] thickness. The bipolar secondary battery 10 of Example 2 includes a cushioning material 50 having a 20 [mm] thickness. The bipolar secondary battery 10 of Example 3 includes a cushioning material 50 having a 35 [mm] thickness. The bipolar secondary battery 10 of Example 4 includes a cushioning material 50 having a 50 [mm] thickness. The bipolar secondary battery 10 of Example 5 includes a cushioning material 50 having a 60 [mm] thickness.

The bipolar secondary batteries of Comparative Examples 1 to 3 were formed by stacking four energy storage modules 30 in which 30 bipolar electrodes 32 were stacked. In the bipolar secondary batteries of Comparative Examples 1 and 2, the constrained form A was set so that the constrained weight of the energy storage module 30 was about 40 [kN]. In the bipolar secondary battery of Comparative Example 3, a constrained form B was adopted in which the constrained weight of the energy storage module 30 was set to about 90 [kN]. The bipolar secondary batteries of Comparative Examples 1 and 2 were configured without a cushioning material. The bipolar secondary battery of Comparative Example 3 was configured to include a cushioning material 50 having thickness of 80 [mm].

### Collision Test

In the collision test, a semi-cylindrical loader of @75 [mm] was caused to collide with each of the bipolar secondary battery 10 of Examples 1 to 5 and the bipolar secondary battery of Comparative Examples 1 to 3 at 50 [G] from the rear. Then, a cell in which the voltage of each cell was 25% lower than that before the test was determined as a short-circuited cell, and in 120 cells, the short-circuited cells were counted. When a cell of ¼ or more of all cells is short-circuited, the collision determination is poor.

### Smoke Test

In the smoke test, the bipolar secondary batteries 10 of Examples 1 to 5 and the bipolar secondary batteries of Comparative Examples 1 to 3 were each heated to 600° C. by installing a heater in the center portion in the front-rear direction and the left-right direction between the second energy storage module from the top and the third energy storage module from the top. The second energy storage module from the top and the third from the top were heated until the temperature on the side opposite the side where the heater was installed exceeded 300° C. Then, the smoke generation profile was measured at a position located 80 [mm] away from the side surface of the energy storage module. When smoke generation of 900° C. or higher continues more than 30 [sec], the smoke generation determination was poor.

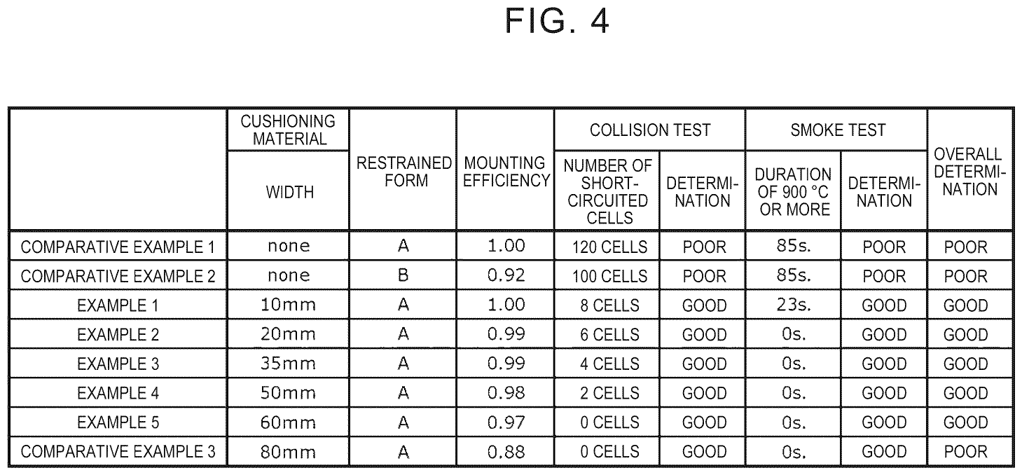

FIG. 4 is a graph showing the results of an effect confirmation test of a bipolar secondary battery. As can be seen from FIG. 4, in the bipolar secondary batteries of Comparative Examples 1 and 2, the collision determination in the collision test was poor. On the other hand, in the bipolar secondary batteries 10 of Examples 1 to 5, the collision determination in the collision test was good. In the bipolar secondary batteries of Comparative Examples 1 and 2, the smoke generation determination in the smoke test was poor. On the other hand, in the bipolar secondary batteries 10 of Examples 1 to 5, the smoke generation determination in the smoke test was good.

### Action

Incidentally, when an external force is input from the side of the bipolar secondary battery 10, if the bipolar secondary battery 10 is deformed and a crack occurs in the separator 36, there is a problem that short-circuiting occurs between the electrodes due to the crack of the separator 36.

The bipolar secondary battery 10 according to the embodiment includes: a stack 20 of energy storage modules 30, each of the energy storage modules 30 being composed of a stack of a bipolar electrode 32 and a separator 36, the bipolar electrode 32 including a cathode active material layer 34 on one surface of a current collector 33 and an anode active material layer 35 on the other surface of the current collector 33, and the energy storage modules 30 being stacked in a vehicle up-down direction in such an attitude that wide surfaces of the energy storage modules 30 face in the vehicle up-down direction; and a cushioning material 50 having a dilatancy property and disposed so as to cover the side peripheral surface of the stack 20 (see FIG. 1).

By providing the cushioning material 50 having a dilatancy property arranged so as to cover the side peripheral surface of the stack 20, the periphery of the bipolar electrode 32 is covered with the cushioning material 50 having a dilatancy property. Therefore, when a strong external force is input from the side of the bipolar secondary battery 10 in a short time due to a collision, the cushioning material 50 having a dilatancy property becomes solid and hardened. As a result, deformation of the bipolar secondary battery 10 is reduced, and cracking of the separator 36 is also reduced. Therefore, short-circuiting between the electrodes can be reduced.

Moreover, the volume efficiency can be improved as compared with the case where the cushioning material 50 is provided on the outside or the inside of the housing accommodating the stack 20. Therefore, it is possible to provide the bipolar secondary battery 10 in which short-circuiting between electrodes is reduced and the volume efficiency is improved.

In the bipolar secondary battery 10 according to the embodiment, a frame-shaped member 38 that holds the periphery of the bipolar electrode 32 is provided, and the cushioning material 50 is disposed so as to cover the side peripheral surface of the frame-shaped member 38 (see FIG. 3).

The cushioning material 50 is disposed so as to cover the side peripheral surface of the frame-shaped member 38 that holds the peripheral edge of the bipolar electrode 32, so that the bipolar electrode 32 is covered with the cushioning material 50 having a dilatancy property through the frame-shaped member 38. Therefore, the external force input from the side of the bipolar secondary battery 10 is dispersed by the frame-shaped member 38. As a result, cracking of the separator 36 is reduced, and short-circuiting between the electrodes can further be reduced.

In the bipolar secondary battery 10 according to the embodiment, the cushioning material 50 is a bag-shaped container enclosing a non-flammable liquid or a flame retardant liquid.

The cushioning material 50 is a bag-shaped container enclosing a non-flammable liquid or a flame retardant liquid. The cushioning material 50 is thus formed with a simple configuration. Moreover, since the cushioning material 50 is made non-flammable or flame retardant, smoking and ignition can be reduced.

In the bipolar secondary battery 10 according to the embodiment, the cushioning material 50 supports the energy storage module 30 (see FIG. 3).

The cushioning material 50 supports the energy storage module 30, so that the cushioning material 50 functions as a spacer that maintains an interval between the energy storage modules 30. Therefore, even if a spacer is not newly installed, deformation such that the bipolar secondary battery 10 is recessed due to, for example, negative pressure is reduced. As a result, deformation of the bipolar secondary battery 10 can be reduced while improving the volume efficiency.

In the bipolar secondary battery 10 according to the embodiment, the cushioning material 50 has a height extending from the lower surface to the upper surface of the stack 20 (see FIG. 2).

The cushioning material 50 has a height extending from the lower surface to the upper surface of the stack 20, so that the entire side peripheral surface of the stack 20 is covered with the cushioning material 50. Therefore, when an external force is input from the side of the bipolar secondary battery 10 due to the collision, the external force is less likely to be applied to the stack 20 due to the cushioning material 50. As a result, cracking of the separator is reduced, and short-circuiting between the electrodes can further be reduced.

The bipolar secondary battery according to the embodiment has been described above based on the embodiment. However, the specific configuration is not limited to this embodiment, and changes in design and the like are allowed without departing from the gist of the disclosure according to each claim of the claims.

In the embodiment, an example is shown in which the cushioning material 50 is arranged so as to cover the side peripheral surface of the stack 20. However, the cushioning material may be disposed so as to cover at least a part of the side peripheral surface.

In the embodiment, an example in which the bipolar secondary battery 10 houses an electrolytic solution inside the energy storage module 30 has been described. However, the bipolar secondary battery may be an all-solid-state battery.

What is claimed is:

1. A bipolar secondary battery comprising:
a stack of energy storage modules, each of the energy storage modules being composed of a stack of a bipolar electrode and a separator, the bipolar electrode including a cathode active material layer on one surface of a current collector and an anode active material layer on another surface of the current collector, and the energy storage modules being stacked in a vehicle up-down direction in such an attitude that wide surfaces of the energy storage modules face in the vehicle up-down direction; and
a cushioning material having a dilatancy property and disposed so as to cover a side peripheral surface of the stack of the energy storage modules.

2. The bipolar secondary battery according to claim 1, further comprising a frame-shaped member that holds a peripheral edge of the bipolar electrode, wherein the cushioning material is disposed so as to cover a side peripheral surface of the frame-shaped member.

3. The bipolar secondary battery according to claim 1, wherein the cushioning material is a bag-shaped container enclosing a non-flammable liquid or a flame retardant liquid.

4. The bipolar secondary battery according to claim 1, wherein the cushioning material supports the energy storage modules.

5. The bipolar secondary battery according to claim 1, wherein the bipolar secondary battery is an all-solid-state battery.
